(19) United States
(12) Patent Application Publication
(10) Pub. No.: US 2007/0100645 A1
(43) Pub. Date: May 3, 2007

(54) Management of a process

(75) Inventor: John M. Spangler, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/261,615

(22) Filed: Oct. 31, 2005

(51) Int. Cl. G06Q 99/00

(52) U.S. Cl. 705/1

(57) ABSTRACT

A method for controlling a process configured to manipulate objects is disclosed. The method includes identifying at least one object to be manipulated within the process. The method also includes consuming at least one resource to manipulate the at least one object and monitoring the consumption of the at least one resource and the manipulation of the at least one object. The method further includes establishing a cost value of the at least one object as a function of the consumption of the at least one resource.

### TECHNICAL FIELD

The present disclosure relates to management of a process and, more particularly, to a method and apparatus for monitoring and controlling a process.

### BACKGROUND

Processes, such as material handling processes, are typically used to manipulate a plurality of objects, such as parts or packages, in one or more stages thereof to transform the objects toward a more desired state. Multiple processes may be interrelated to perform successive manipulations to produce a desired final product. Typically, each of the multiple processes and/or stages has a different throughput capacity and/or has a different processing cycle time per object or per a group of objects. Throughput and cycle times are typically a function of the available resources for a given stage or process, e.g., the consumables available to manipulate the objects within a particular process or stage. Resources are often limited and the allocation of those resources throughout a process can impact the cost associated with manipulating the objects and a cumulative cost of operating the process to achieve a desired manipulation.

U.S. Pat. No. 6,739,512 (“the '512 patent”) issued to Guerrero et al. discloses a system for tracking components within a network environment. Specifically, the '512 patent discloses a system including a plurality of manufacturing entities configured to manipulate various features of components and a component tracking module configured to be in communication with the plurality of entities. As components move through and between the manufacturing entities, the component tracking module receives data, such as test reports, performance criteria, variances, and location, associated with the components. This data may be accessed by users and/or operators of the manufacturing entities to monitor and track the plurality of components in order to indicate receipt of goods, generate purchase orders, pay invoices, and update and maintain inventory accounts automatically. Additionally, the data may be used to aid collaboration to integrate efforts between the entities to compare and adjust the production of the components. Furthermore, the data may be used to identify objects that were manipulated similarly to an identified inferior component.

Although the '512 patent may track the location of components manipulated by a plurality of manufacturing entities, it may not identify information regarding the allocation of resources between the entities. Additionally, the '512 patent may not reallocate resources from one or more entities having a surplus of resources to an entity having a deficiency in resources. Furthermore, the '512 patent may not allocate resources as a function of a cost associated with manipulating the components.

The present disclosure is directed to overcoming one or more of the problems set forth above.

### SUMMARY OF THE INVENTION

In one aspect, the present disclosure is directed to a method for controlling a process configured to manipulate objects. The method includes identifying at least one object to be manipulated within the process. The method also includes consuming at least one resource to manipulate the at least one object and monitoring the consumption of the at least one resource and the manipulation of the at least one object. The method further includes establishing a cost value of the at least one object as a function of the consumption of the at least one resource.

In another aspect, the present disclosure is directed to a system. The system includes a process having at least one stage within which at least one object is manipulated. At least one resource is affiliated with the at least one stage. The system also includes a controller configured to monitor a consumption of the at least one resource within the at least one stage and to communicate a signal when the consumption exceeds a predetermined consumption.

In yet another aspect, the present disclosure is directed to a method for controlling a material handling process as a function of a cost of manipulating a plurality of objects. The method includes identifying the plurality of objects to be manipulated within the process. The method also includes determining a schedule to manipulate the plurality of objects and manipulating the plurality of objects. The method further includes monitoring a manipulation of at least one of the plurality of objects and determining the cost of manipulating the plurality of objects.

### BRIEF DESCRIPTION OF THE DRAWINGS

FIG. 1 is an exemplary diagrammatic illustration of a process in accordance with the present disclosure;

FIG. 2 is an exemplary flow chart of a method to control the process of FIG. 1; and

FIG. 3 is an exemplary flow chart of a method of monitoring the manipulation of objects within the process of FIG. 1.

### DETAILED DESCRIPTION

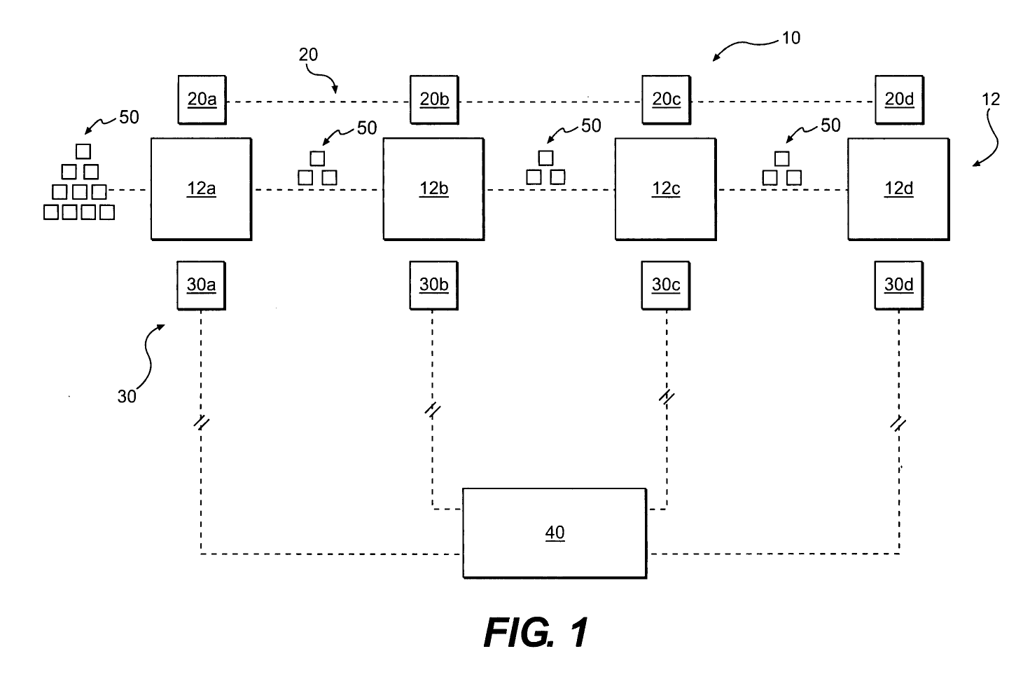

FIG. 1 illustrates an exemplary process 10 such as, for example, a material handling process, within which one or more objects 50 may be manipulated. Specifically, process 10 may include one or more stages 12 configured individually and/or cooperatively, within which objects 50 may be manipulated. Process 10 may also include resources 20 which may be consumed within stages 12 to affect the manipulation of objects 50. Process 10 may also include communicators 30 and a controller 40 configured to monitor the manipulation of objects 50 and control the allocation of resources 20 within process 10. It is contemplated that process 10 may be configured to affect, via stages 12, any type of manipulation such as, for example, tooling, coating, geometry shaping, heat treating, packaging, transporting, arranging, refining, assembling, and/or any other type of manipulation. It is also contemplated that process 10 may be interrelated with additional processes (not shown) within which objects 50 may also be manipulated previously, subsequently, and/or concurrently so as to, for example, transform raw materials into finished products. It is further contemplated that process 10 may include any type of process configured to affect any type of manipulation known in the art such as, for example, a refining process, a fabrication process, a manufacturing process, a painting process, an assembly process, a packaging process, a warehousing process, or a combination of one or more such processes.

Stages 12 may include a first, second, third, and fourth stages 12a, 12b, 12c, 12d configured to affect successive and/or concurrent operations configured to manipulate objects 50. A further description of stages 12 is made below with reference to first stage 12a for clarification purposes only. It is noted that the description of first stage 12a is applicable to second, third, and fourth stages 12b, 12c, 12d. Specifically, first stage 12a may include any operation configured to perform one or more manipulations of objects 50 such as, for example loading, welding, bolting, coating, washing, heating, cleaning, and/or any operation known in the art. For example, first stage 12a may be configured to receive a first object in a less desirable state, affect one or more manipulations on the first object, and deliver the first object to second stage 12b in a more desirable state. It is contemplated that process 10 may include any number of stages 12 and is illustrated as having at least four stages for explanatory purposes only.

Resources 20 may be allocated with respect to stages 12 and may be configured to be consumed to manipulate objects 50. For example, the resources may include machinery, e.g., robots or tooling, labor, e.g., manual labor or mechanized labor, utilities, e.g., electricity or fuel, vehicles, e.g., carts or trucks, supplies, e.g., coatings, packaging materials, time, and/or other consumables configured to be affiliated with and/or utilized by one or more stages 12 to, for example, change the physical characteristics and/or the arrangement of objects 50. Resources 20 may be allocated among stages 12 as first, second, third, and fourth resources 20a, 20b, 20c, 20d, associated with first, second third, and/or fourth stage 12a, 12b, 12c, 12d, respectively. Resources 20 may incur a cost associated with the operation and/or consumption thereof. A cost of resources 20 may be a function of the use, e.g., a cost of electricity, may be determined whether or not consumed, e.g., a cost of labor, and/or may be based on any other suitable manner. It is contemplated that the cost of resources may include a currency expense of resources 20, a value attributable to the utilization of resources 20, a worth of time associated with not manipulating other objects, and/or any type of expense applicable to resources 20. It is also contemplated that resources 20 may be consumed within stages 12 to establish a desired manipulation of objects 50 such as, for example, by being operated, by being utilized on a one-time basis, by being recycled and utilized on a multi-time basis, and/or consumed in any suitable manner. It is further contemplated that resources 20 may be allocated to more than one of stages 12 in any suitable distribution or arrangement, as desired.

Communicators 30 may be disposed relative to stages 12 to communicate with resources 20 and controller 40. Specifically communicators 30 may include first, second, third, and fourth communicators 30a, 30b, 30c, 30d each associated with first, second, third, and fourth stage 12a, 12b, 12c, 12d. For example, communicators 30 may include sensors, audio and/or visual alarms, timers, displays, monitors, input/output devices, barcode scanners, computers, global positioning systems, radio frequency transmitters, infrared and/or optical transmitters, cellular telephones, pagers, walkie-talkies and/or any other known indicator. Communicators 30 may each be configured to monitor and/or display conditions of one or more resources of stages 12. For example and with reference to first stage 12a for clarification purposes only, communicator 30a may be configured to monitor a time that one or more of objects 50 may be manipulated by first stage 12a and communicate that time to controller 40. Communicator 30a may also be configured to display a warning light relative to first resources 20a with respect to a time that objects 50 are manipulated within first stage 12a. Communicator 30a may also be configured to monitor a consumption of resources 20a within first stage 12a and communicate data indicative of such a consumption to controller 40, e.g., communicators 30a may monitor a consumption of electricity required to operate machinery to manipulate objects 50 within first stage 12a. Communicator 30a may further be configured to monitor an allocation of first resources 20a with respect to the manipulation of objects 50 within first stage 12a to determine, for example, a surplus or deficiency in first resources 20a desired to manipulate objects 50 within first stage 12a. It is contemplated that communicator 30 may include any number of communicators each operatively associated with stages 12 and/or resources 20 and configured to communicate with controller 40. It is also contemplated that process 10 may include additional communicators (not shown) configured to monitor and/or display resources within additional processes (not shown) or may include fewer communicators than that illustrated. It is further contemplated that communicators 30 may interact with controller 40 in any suitable manner, such as, for example, via radio frequencies, hardwired connections, optically, via the Internet, via a local area network, and/or via any manner known in the art.

Controller 40 may be configured to monitor process 10 and control the allocation of resources 20 relative to stages 12. Controller 40 may include one or more microprocessors, a memory, a data storage device, a communications hub, and/or other components known in the art. It is contemplated that controller 40 may be integrated within a general process control system capable of controlling additional functions and/or operations of process 10 and/or stages 12. It is also contemplated that controller 40 may be configured to control and/or affect the operation of additional processes, e.g., previous and/or subsequent processes with respect to process 10. It is further contemplated that controller 40 may further include additional and/or different components, such as, for example, an input device, an output device, a display, a printer (not shown), an audio-video device (not shown), removable data storage devices (not shown), and/or other components known in the art.

Specifically, controller 40 may be configured to receive inputs from one or more of communicators 30 indicative of various indicia and/or criteria of process 10 and/or stages 12. Controller 40 may perform one or more algorithms to determine appropriate output signals to affect control of stages 12 and/or resources 20. Controller 40 may also be configured to perform one or more algorithms to monitor process 10 as a function of resources 20 and objects 50. For example, controller 40 may be configured to monitor a consumption of first resources 20a within first stage 12a with respect to objects 50 being manipulated therein and control a reallocation of resources 20 to and/or from first stage 12a as a function of a deficiency and/or a surplus of first resources 20a relative to a desired amount of resources 20a within first stage 12a. As such, controller 40 may be configured to reallocate resources 20 within process 10 and among stages 12 to improve the consumption of resources 20 utilized to manipulate the objects, e.g., controller 40 may reduce a cycle time of an object through stage 12a by reallocating surplus resources from one or more of second, third, or fourth stages 12b, 12c, 12d to cure deficient resources within first stage 12a.

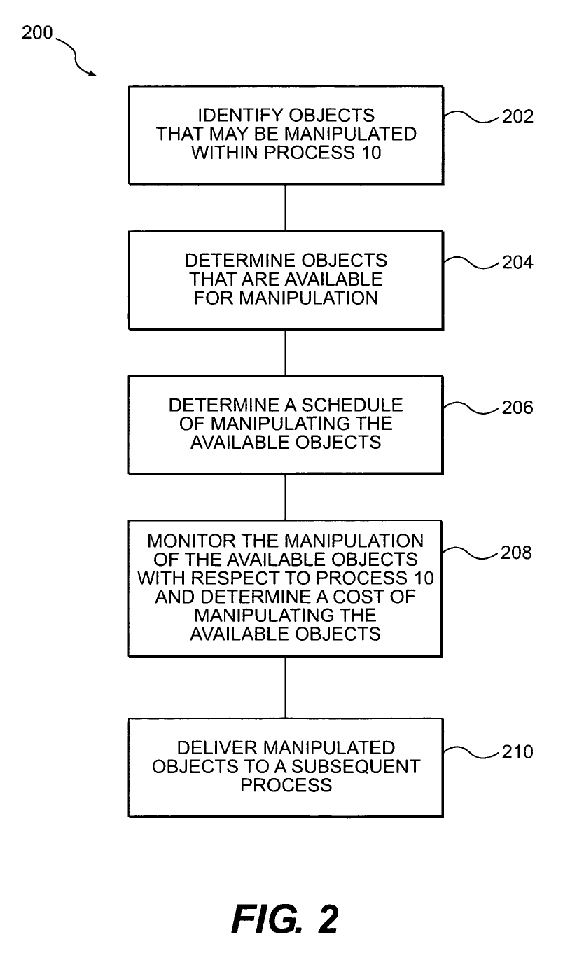

FIG. 2 illustrates an exemplary first method 200 which may be performed by controller 40 to monitor process 10 and/or control the allocation of resources 20. Specifically, first method 200 may be configured to identify one or more of objects 50 that may be manipulated within stages 12 of process 10, step 202, and determine one or more of objects 50 that are available for manipulation, step 204. First method 200 may also be configured to determine a schedule of manipulating the available objects, step 206, and monitor the manipulation of the available objects with respect to process 10, step 208. First method 200 may further be configured to deliver the manipulated objects, step 210.

Step 202 may identify a first subgroup of objects 50 that may be manipulated within one or more of stages 12 of process 10. Specifically, controller 40 may be configured to communicate with one or more databases and/or receive one or more inputs indicative of one or more objects 50 that may be desired and/or required to be manipulated. For example, controller 40 may identify such objects by referencing one or more purchase orders electronically and/or physically stored within or external to controller 40. Such purchase orders may include data indicative of a desired quantity of finished products and/or a desired delivery schedule thereof. Controller 40 may be configured to interpret such data and identify the first subgroup of objects to establish the desired quantity and/or delivery of finished products. It is contemplated that the first subgroup of objects desired to be manipulated within process 10 may have different cycle times, different lead times, and/or have different priorities for manipulation to achieve the desired quantity and/or delivery of the finished products. As such, step 202 may be configured to account for different types of objects desired to be manipulated within process 10 to achieve one or more different quantities, types of finished products, and/or delivery schedules thereof.

Step 204 may determine a second subgroup of objects 50 available for manipulation. Specifically, controller 40 may be configured to communicate with one or more databases and/or receive one or more inputs indicative of one or more of objects 50 that are available to be manipulated within process 10. For example, process 10 may not be capable and/or it may not be desirous to manipulate objects 50 within process 10 until objects 50 have been manipulated within one or more previous processes. As such, controller 40 may compare the first subgroup of objects with one or more objects 50 that have been manipulated within the one or more previous processes and establish the second subgroup as those objects meeting each criteria. It is contemplated that the one or more previous processes may manipulate objects that may not be desired to be or may not require manipulation within process 10. It is also contemplated that the one or more previous processes may affect the manipulation of various objects with an unsuitable delivery to process 10, e.g., manipulate objects which are not to be manipulated within process 10, manipulate objects having disparate cycle times between the previous process and process 10, and/or manipulate objects in other manners which adversely impact the manipulation of those objects within process 10. As such, step 204 may be configured to account for uncoordinated manipulation between process 10 and one or more previous processes.

Step 206 may determine a schedule to manipulate the available objects, e.g., the second subgroup of objects, and determine a schedule of resources 20 to manipulate the available objects. Specifically, controller 40 may be configured to perform one or more algorithms to arrange the available objects in a schedule to be manipulated within process 10. For example, controller 40 may compare one or more characteristics of the available objects, such as, for example, physical size of the objects, cycle times, lead times, requirements of resources 20, and/or any other criteria, to determine a suitable schedule. Step 206 may determine first, second, third, fourth resources 20a, 20b, 20c, 20d associated with first, second, third, and fourth stages 12a, 12b, 12c, 12d that are desired and/or necessary to manipulate the available objects within stages 12. It is contemplated that resources 20 may be allocated and reallocated between stages 12 as desired and controller 40 may be configured to estimate a future time when resources originally desired to be associated with first stage 12a may be desired to be reallocated and associated with second stage 12b. It is contemplated that step 206 may establish a schedule of available objects and predict a desired allocation and/or reallocation of resources 20 as a function of any desired criteria, such as, for example, historical data indicative of a time of manipulation for similar objects. It is also contemplated that the schedule of available objects may include objects arranged in series, objects arranged in parallel, objects identified as capable of being manipulated in one or more stages 12 substantially simultaneously, and/or in any other schedule. It is further contemplated that a determined schedule may be based on a predicted consumption of resources 20, that one or more determined schedules may be compared with one another, and one of the compared schedules may be selected as a function of the predicted consumption of resources. As such, step 206 may be configured to account for differences in manipulations among stages 12 and differences in resources 20.

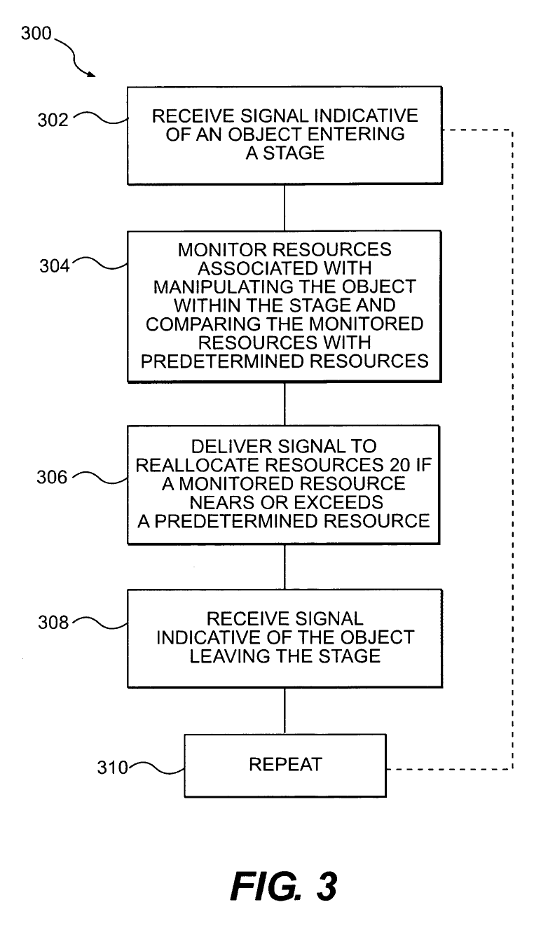

Step 208 may monitor the manipulation of the available objects within process 10. Specifically, controller 40 may be configured to receive one or more inputs from communication devices 30 indicative of one or more operational conditions of process 10. For example, controller 40 may receive signals indicative of a location of objects within process 10, of the amount of resources 20 being consumed within one or more stages 12, and/or receive additional signals. Controller 40 may also deliver signals indicative of shortages of resources 20 within one or more of stages 12, indicate alarms and/or visual devices within one or more stages 12 to reallocate resources among stages 12, and/or deliver additional signals. A further description of step 208 is made below with reference to FIG. 3. Step 208 may also be configured to populate one or more databases with data indicative of the received and/or delivered signals. Such databases may be available in substantially real time to indicate up to date consumption of resources 20, location of objects 50 within process 10, an amount of resources 20 consumed to manipulate objects 50 to date, and/or indicate other desired operating resources of process 10. Additionally, controller 40 may be configured to determine a cost value by relating costs associated with the consumption of resources 20 with objects 50 being manipulated such as, for example, comparing the electricity costs associated with operating machinery to manipulate objects 50 within first stage 12a and track such costs in real time to indicate the total costs expended to manipulate objects 50.

Step 210 may deliver the objects manipulated within process 10 to a subsequent process. Specifically, controller 40 may identify and/or indicate manipulated objects as ready for delivery to a subsequent process. It is contemplated that first method 200 may be repeated at any desired frequency such as, for example, daily, at the start of a work shift, at the receipt of a purchase order for a quantity of finished products, and/or at any other frequency.

FIG. 3 illustrates an exemplary second method 300 which may be performed by controller 40 within step 208 of first method 200 and which may be configured to monitor objects 50 manipulated within process 10. Specifically, second method 300 may include receiving a signal indicative of an object entering a stage, step 302. Second method 300 may also include monitoring resources 20 associated with manipulating the object within the stage and comparing the monitored resources with predetermined resources, step 304. Second method 300 may also include delivering a signal to reallocate resources 20 if a monitored resource nears or exceeds a predetermined resource, step 306. Second method 300 may further include receiving a signal indicative of the object leaving the stage.

Step 302 may include receiving a signal indicative of an object entering a stage. Specifically, one or more communicators 30 may deliver a signal to controller 40. For example, first communicator 30a may identify when an object enters first stage 12a by, for example, scanning a barcode or other indicia operably connected to the object as the object becomes affiliated with first stage 12a. It is contemplated that communicators 30 may identify objects within stages 12 by any suitable mechanism, such as, for example, scanning a bar code on a carrier supporting the object, sensing an emitted global positioning system signal, and/or other location identification mechanisms known in the art.

Step 304 may be configured to monitor one or more resources 20 associated with manipulating the object within the stage. Specifically, controller 40 may be configured to monitor and/or store data indicative of a time the object may be affiliated with a stage, the amount of resources consumed to manipulate the object, and/or monitor other resources known in the art. For example, controller 40 may be configured to monitor the time an object is affiliated with first stage 12a and monitor the amount of electricity consumed within first stage 12a during the same time. As such, controller 40 may be configured to relate the object and the amount of electricity consumed to manipulate the object within first stage 12a. It is contemplated that controller 40 may be configured to monitor any type of resource such as, for example, electricity, fuel, supplies, and/or labor, associated with manipulating objects 50 within stages 12 and to functionally relate any type of resource with objects 50 manipulated with any of stages 12. As such, step 304 may be configured to establish a cost value of manipulating objects 50 as a function of the time the object is manipulated within a stage and the amount of consumed resources during that time. It is contemplated that the manipulation of objects 50 may include idle periods wherein characteristics of objects 50 may not be affected, e.g., objects 50 may be temporarily stored within one or more stages 12 pending manipulation within that stage. As such, controller 40 may be configured to disregard or include such an idle period during monitoring of resources 20 and thus in determining a cost value, as desired. It is further contemplated resources 20 may include a plurality of resources and that controller 40 may be configured to monitor each of the plurality of resources and establish a cost value of manipulating objects 50 as a function of the consumption of the plurality of resources.

Step 306 may include delivering a signal to reallocate resources 20 if a monitored resource nears or exceeds a predetermined resource value. Specifically, controller 40 may be configured to deliver a signal to one or more of communicators 30 to affect a reallocation of resources 20 among stages 12. For example, controller 40 may receive a signal from first communicator 30a indicating that a time an object has been manipulated within first stage 12a exceeds or is about to exceed a predetermined desired time for manipulation of such an object. Controller 40 may determine that such a signal is indicative of a deficiency in first resources 20a and may, as a result, deliver a signal to one or more of second, third, or fourth communicators 30b, 30c, 30d to indicate the determined deficiency. As such, second, third, or fourth resources 20b, 20c, 20d may be reallocated to first stage 12a to cure the deficiency therein.

Step 308 may include receiving a signal indicative of the object leaving the stage. Similar to step 302, one or more communicators may deliver a signal to controller 40. For example, first communicator 30a may identify when the object leaves first stage 12a by, for example, scanning a barcode or other indicia operably connected to the object as the object ceases affiliation with first stage 12a and/or when the object becomes affiliated with second stage 12b. Similar to step 302, communicator 30a may deliver a signal to controller 40 to indicate that the object may no longer be affiliated with first stage 12a via any suitable mechanism known in the art. It is contemplated that controller 40 may only receive signals indicative of objects entering stages 12 and that controller may be configured to determine that a signal indicative of an object entering a given stage may also be indicative of the object leaving a previous stage. It is also contemplated that controller 40 may only receive signals indicative of object leaving stages 12 and that controller may be configured to determine that a signal indicative of an object leaving a given stage may also be indicative of the object entering a subsequent stage.

Step 310 may include second method 300 being repeated for all or substantially all objects 50 manipulated within process 10. Second method 300 may also be repeated for a given object through each of stages 12. As such, controller 40 may be configured to monitor the available objects manipulated within process 10 and stages 12. It is contemplated that controller 40 may be configured to perform second method 300 substantially simultaneously for a plurality of objects 50 that may be manipulated within a plurality of stages 12, so as to monitor the manipulation of objects 50 in substantially real time. It is also contemplated that second method 300 may be repeated at any frequency to monitor and establish data indicative of the manipulation of the available objects, such as, for example, substantially continuously, periodically, daily, at discrete time intervals, and/or at any interval as desired. It is further contemplated that first and second methods 200, 300 may each be repeated as desired to monitor and control process 10 to affect manipulation of objects 50 and deliver manipulated objects 50 to a subsequent process.

It is noted that the description of process 10 above is for explanatory purposes only and is not limited to the scope described. The description of process 10 is applicable to process 10 embodying any degree of object manipulation. For example, the above description includes process 10 embodied as a particular processing function, e.g., a paint line, wherein stages 12 are stations therein, e.g., a loading station, a painting station, and/or a curing station, such that process 10 is interrelated with other processing functions, e.g., a fabrication line and/or an assembly line. The above description also includes process 10 embodied as a industrial operation e.g., a manufacturing plant, wherein stages 12 are processing functions therein, e.g., a fabrication line, a paint line, and/or an assembly line, such that process 10 is affiliated with other industry operations, e.g., a mining operation and/or a retail selling operation. The above description also includes process 10 embodied as a processing station, e.g., a painting station, wherein stages 12 are operating areas therein, e.g., a staging area, a storage area, and/or a supply area, such that process 10 is affiliated with other processing stations, e.g., a loading station and/or a curing station.

### INDUSTRIAL APPLICABILITY

The disclosed system may be applicable to any process. The disclosed system may be configured to monitor and/or control any process within which one or more objects may be manipulated. Additionally, the disclosed system may be configured to monitor and selectively reallocate resources from one stage to another. The operation of controller 40 and first and second methods 200, 300 is explained below with reference to process 10 configured as a painting process for clarification purposes only, and it is noted that the explanation thereof is applicable to process 10 configured as any process.

Process 10 may be configured to apply a coating to objects 50 and stages 12 may be configured to affect manipulations such as, for example, loading, washing, masking, priming, coating, curing, unmasking, unloading, and/or other manipulations as is known in the art. Process 10 may, for example, receive objects 50 from a fabrication process configured to, for example, stamp, extrude, weld, and/or form objects 50 in any suitable manner known in the art. Process 10 may deliver objects 50 to an assembly process configured to, for example, connect, attach, link, and/or otherwise combine objects 50 into a finished product.

Referring to FIGS. 1 and 2, controller 40 may determine one or more of objects 50 desired to be painted within process 10 as a function of purchase orders received for a given quantity of finished products assembled by the assembly process for a given lead time (step 202). One or more of objects 50 desired to be assembled may also be desired to be fabricated by the fabrication process. The fabrication process may, however, not form objects 50 according to the given quantity and/or lead time of the finished products. As such, controller 40 may determine the one or more of objects 50 that are desired to be painted within process 10 and that are fabricated by the fabrication process (step 204).

Controller 40 may determine a schedule desired to manipulate objects 50 available to be painted (step 206). Controller 40 may perform one or more algorithms to determine a schedule as a function of cycle times and lead times of manipulating the available objects and the desired quantity and delivery of the finished products. For example, controller 40 may compare the time required to paint one or more of the available objects with the time required to assemble painted objects into finished products. It is contemplated that controller 40 may determine the schedule as a function of only a portion of the available products, such as, by determining a schedule based only on physically large objects, or objects known to consume relatively large amounts of resources 20 within process 10 e.g., frames and/or chassis. As such, controller 40 may disregard other available objects, such as, relatively small objects, and/or objects known to consume relatively small amounts of resources 20 within process 10. For example, controller 40 may be configured to disregard bolts or washers, that are desired to be painted and assembled yet that may not significantly impact the schedule of process 10.

Controller 40 may also be configured to predict an allocation of resources 20 within process 10 as a function of the determined schedule (step 206). Specifically, controller 40 may be configured to predict the consumption of resources 20 desired to paint objects 50. For example, controller 40 may predict a desired consumption of labor within a masking stage of process 10 as a function of the quantity or type of objects 50 desired to be painted. Controller 40 may perform one or more algorithms to analyze objects 50 with respect to predetermined times. Such predetermined times may be indicative of a desired time to manipulate objects 50 within stages, e.g., the loading stage and/or the washing stage, configured to manipulate objects 50 before the masking stage, to predict a desired consumption of labor within the masking stage. It is contemplated that the amount of labor affiliated with stages 12 may be limited, e.g., labor may not be able to be consumed within all of stages 12 of process 10 concurrently because sufficient labor allocated to each of stages 12 may not be available and/or desirable, e.g., because sufficient labor allocated to each of stages 12 may be too expensive. As such, controller 40 may, for example, allocate the available labor to the loading stage to complete the manipulation therein and predict a reallocation of the available labor from the loading stage to the masking stage to complete the manipulation therein. It is contemplated that controller 40 may communicate one or more signals to communicators 30 to indicate to the available labor when such labor may be allocated to the loading stage and when such labor may be reallocated to the masking stage. For example, controller 40 may communicate a signal to the loading stage when the labor affiliated with the loading stage may be desired to be reallocated to the masking stage. It is also contemplated that controller 40 may communicate a signal to resources 20 to indicate a future time when resources 20 may be desired to be reallocated to the masking stage, e.g., controller 40 may communicate a signal to indicate a future time when labor affiliated with the loading stage may be desired to be reallocated to the masking stage.

Objects 50 may then be manipulated within process 10 to apply a desired coating thereon. Resources 20 may be consumed within stages 12 to establish the desired manipulation. For example, a loading stage may consume labor, time, space, and/or fuel to transport available objects from the fabrication process to process 10. Similarly, a masking stage may consume labor, time, space, and/or materials, e.g., tape, to cover portions of the manipulated objects that are not desired to receive a coating. Additionally, a coating stage may consume robotics, time, space, and/or material to apply a coating, e.g., a paint, to the objects. Furthermore, a curing stage may consume electricity, time, and/or space to expose objects 50 to an elevated temperature within an oven. It is noted that the above explanation is exemplary and provided for explanatory purposes only.

Referring to FIGS. 1-3, controller 40 may monitor the consumption of one or more of the resources 20 consumed within stages 12 and determine a cost associated with manipulating objects 50 within process 10 (step 208 and second method 300). For example, controller 40 may be configured to receive signals indicative of the quantity and/or type of objects 50 being cured within the curing stage, e.g., scanned indicia. Additionally, controller 40 may compare a cost of electricity per unit time with the amount of electricity and time consumed to cure objects 50 within a curing stage of process 10. As such, controller 40 may compare the cost of electricity and objects 50 cured within the curing stage and determine a cost of curing objects 50. It is contemplated that controller 40 may be configured to similarly determine costs associated with any other resource 20 consumed within one or more stages 12.

Because controller 40 performing first and second methods 200, 300 may be configured to control process 10 to affect manipulation of objects 50 therein and monitor the consumption of resources 20, controller 40 may obtain information regarding the allocation of resources 20 within process 10 and, in particular, among stages 12. As such, controller 40 may be configured to reallocate resources from one of stages 12 having a surplus of resources 20 to another of stages 12 having a deficiency in resources 20. Additionally, controller 40 may control process 10 as a function of a cost value of consuming resources 20 and may reduce costs associated with manipulating objects 50. Furthermore, because controller 40 may monitor the consumption and allocation of resources 20 as objects 50 are manipulated within process 10, controller 40 and first and second methods 200, 300 may provide a substantially real time management of process 10.

It will be apparent to those skilled in the art that various modifications and variations can be made to the disclosed system for management of a process. Other embodiments will be apparent to those skilled in the art from consideration of the specification and practice of the disclosed system. It is intended that the specification and examples be considered as exemplary only, with a true scope being indicated by the following claims and their equivalents

What is claimed is:

1. A method for controlling a process configured to manipulate objects, the method comprising:
identifying at least one object to be manipulated within the process;
consuming at least one resource to manipulate the at least one object;
monitoring the consumption of the at least one resource and the manipulation of the at least one object; and
establishing a cost value of the at least one object as a function of the consumption of the at least one resource.

2. The method of claim 1, wherein:
the process includes a plurality of stages, each stage configured to affect a manipulation of the objects; and
monitoring the consumption of the at least one resource includes sensing a time the at least one object is manipulated in at least one of the plurality of stages.

3. The method of claim 2, wherein sensing a time includes sensing indicia operatively associated with the at least one object when the object becomes affiliated with the at least one of the plurality of stages.

4. The method of claim 1, wherein the process includes a plurality of stages, the method further including:
automatically reallocating the at least one resource among the plurality of stages.

5. The method of claim 4, wherein automatically reallocating the at least one resource includes:
comparing the monitored consumption of the at least one resource within at least one of the plurality of stages with a predetermined value;
determining a deficiency in the at least one resource if the monitored consumption is greater than the predetermined value; and
delivering a signal indicative of the determined deficiency within at least one of the plurality of stages to a communicator operatively associated with another one of the plurality of stages.

6. The method of claim 1, wherein consuming at least one resource includes consuming a plurality of resources and establishing the cost value includes functionally relating one or more of the plurality of resources with one another.

7. The method of claim 6, wherein:
the process includes at least one stage; and
establishing the cost value includes:
determining the amount of resources consumed within the at least one stage during a given time period, determining a cost associated with each of the consumed resources,
determining at least one object of the plurality of objects manipulated within the at least one stage during the given time period, and
functionally relating the cost associated with each of the consumed resources with the determined at least one object to establish the cost value of manipulating the at least one object.

8. The method of claim 7, wherein the at least one object includes a plurality of objects and determining the cost value of the at least one object includes determining a cost value of each of the plurality of objects.

9. A material handling process comprising:
at least one stage within which at least one object is manipulated;
at least one resource affiliated with the at least one stage; and
a controller configured to monitor a consumption of the at least one resource within the at least one stage and to communicate a signal when the consumption exceeds a predetermined consumption.

10. The process of claim 9, wherein the consumption of the at least one resource is indicative of a time the at least one object is manipulated within the at least one stage and the predetermined consumption is indicative of a desired length of time to manipulate the first object.

11. The process of claim 9, wherein the consumption of the at least one resource is indicative of a time the at least one object is manipulated within the at least one stage and the predetermined consumption is indicative of an average time necessary to manipulate the first object within the at least one stage.

12. The process of claim 9, wherein:
the at least one stage is a plurality of stages; and
communication of the signal is configured to reallocate resources from one of the plurality of stages to another one of the plurality of stages.

13. The process of claim 9, further including:
indicia, indicative of data, operatively associated with the at least one object;
at least one device configured to interpret the indicia and communicate a signal to the controller.

14. The process of claim 9, wherein the at least one object is a plurality of objects, the at least one resource is a plurality of resources, the at least one stage is a plurality of stages, and the controller is further configured to:
determine a schedule of manipulating the plurality of objects; and
predicting an allocation of the resources among the plurality of stages desired to manipulate the plurality of objects.

15. The process of claim 14, wherein the controller is further configured to predict a reallocation of the resources among the plurality of stages.

16. The process of claim 15, wherein the controller is further configured to communicate a second signal, the second signal configured to indicate at least one predicted reallocation of resources.

17. The process of claim 14, wherein the controller is further configured to:
identify a first plurality of objects that may be manipulated within the process;
determine a second plurality of objects that are available for manipulation within the process; and
determine the schedule as a function of the first and second pluralities of objects.

18. The process of claim 14, wherein:
the first plurality of objects are objects desired to be manipulated to form at least a portion of a finished product; and
the second plurality of objects are a subgroup of the first plurality of objects that are pending manipulation by the process.

19. A method for controlling a material handling process as a function of a cost of manipulating a plurality of objects comprising:
identifying the plurality of objects to be manipulated within the process;
determining a schedule to manipulate the plurality of objects;
manipulating the plurality of objects;
monitoring a manipulation of at least one of the plurality of objects; and
determining the cost of manipulating the plurality of objects.

20. The method of claim 19, further including consuming at least one resource to affect the manipulation of the plurality of objects.

21. The method of claim 19, further including predicting a desired allocation of at least one resource within the process.

22. The method of claim 21, further including communicating a signal indicative of the desired allocation to at least one communicator, the signal configured to indicate the desired allocation to the at least one resource.

23. The method of claim 19, further including:
manipulating the plurality of objects within a plurality of stages; and
reallocating the at least one resource among the plurality of stages.

24. The method of claim 19, wherein the process is a painting process, wherein:
identifying a plurality of objects includes determining a first plurality of objects desired to be painted and assembled within an assembly process to form at least a portion of a finished product; and
determining a schedule of manipulation includes comparing times desired to paint each of the plurality of objects with times desired to assemble the plurality of objects within the assembly process.
